(19) United States
(12) Patent Application Publication
(10) Pub. No.: US 2015/0274077 A1
(43) Pub. Date: Oct. 1, 2015

(54) CONVEX MIRROR FOR LARGE VEHICLES

(71) Applicant: Caterpillar Global Mining LLC, Oak Creek, WI (US)

(72) Inventors: Ritesh Kamalaksh Gaonkar, Decatur, IL (US); Eugene Yefim Grinberg, Mahomet, IL (US)

(73) Assignee: Caterpillar Global Mining LLC, Oak Creek, WI (US)

(21) Appl. No.: 14/242,471

(22) Filed: Apr. 1, 2014

(51) Int. Cl. B60R 1/08; G02B 5/10

(52) U.S. Cl. CPC B60R 1/082; G02B 5/10

(57) ABSTRACT

A rear view mirror for a vehicle is disclosed. The rear view mirror includes a continuous reflective surface of varying convexity. The continuous reflective surface is defined by a horizontal quadratic equation and a vertical quadratic equation. Using the two quadratic equations to define the curvature of the continuous reflective surface provides for a relatively flat portion in the middle of the minor that is surrounded by portions of higher convexities. The relatively flat portion assists the operator in depth perception while the surrounding portions of higher convexities further assists the operator in terms of reflecting expanded views and therefore better coverage of blind spots.

### BACKGROUND

1. Technical Field:

This disclosure relates to a convex rear view mirror for large vehicles. More specifically, this disclosure relates to a rear view mirror with a continuous reflective surface having a parabolic curvature defined by quadratic equations in the vertical and horizontal directions.

2. Description of the Related Art:

Most vehicles employ rear view minors that enable the drivers to see behind and/or to the side of the vehicle without turning their heads. For large vehicles, such as trucks and buses, such rear view mirrors include a pair of exterior, side-mounted mirrors, commonly known as “side view” mirrors that are mounted on a forward portion of the driver and passenger doors.

Rear view mirrors that enable a driver to look behind or to one side of a vehicle may be classified as flat, convex or aspherical mirrors. A flat minor has a generally planar reflective surface that tends to produce true and undistorted reflections of objects and provide the driver with good depth perception. However, because the field of vision provided by planar reflective surfaces is relatively narrow, flat minors may be characterized by one or more blind spots. In order to see objects in blind spots or expand the field of vision, a driver must move his or her head with respect to the mirror. In contrast, a convex mirror has a curved reflective surface and, when compared to a flat mirror, is generally characterized by a greater field of vision and smaller blind spots. As the curvature of the continuous reflective surface is increased, the field of vision for the convex minor increases while the sizes of the blind spots decrease. However, convex mirrors distort the images of the reflected objects and provide poor depth perception, Furthermore, the distortion and poor depth perception tends to worsen as the curvature of the continuous reflective surface increases.

To overcome these problems, some rear view mirrors are a combination of a planar (or relatively planar) reflective surface and a convex reflective surface. Reflections appearing in the planar (or relatively planar) reflective surface may be true and undistorted with good depth perception, but the narrow field of vision results in one or more blind spots. The convex reflective surface compensates for the relatively narrow field of vision and the blind spots of the planar reflective surface, while reflecting somewhat distorted images and providing poor depth perception. While the transition from the planar reflective surface to the convex reflective surface may be smooth, the transition between the planar and convex reflective surfaces is relatively sharp and may affect proper depth perception.

Other rear view mirrors may include two or more convexly curved reflective surfaces, each of which is curved to a different extent as disclosed in U.S. Pat. No. 6,069,755 and U.S. Pat. No. 8,172,411. For example, U.S. Pat. No. 6,069,755 discloses a rear view mirror with a unitary reflective surface that includes numerous curved surfaces joined together to provide a convex reflective surface of a varying average curvature. The average curvature of the mirror disclosed in the '755 patent increases in a vertical direction from the top to the bottom of the mirror and the average curvature increases in a horizontal direction away from the vehicle.

Alternatively, U.S. Pat. No. 8,172,411 discloses a rear view mirror with a reflective surface having a first convex curvature across the entire reflective surface. The reflective surface also includes discreet second convex curvatures disposed on the convex reflective surface and arranged in columns and rows extending across the reflective surface. The first convex curvature has a greater radius and a lesser degree of curvature than the second convex curvatures. As a result, the rear view mirror of the '411 patent provides a composite reflective surface of varying radii of curvatures arranged in linear patterns of alternating radii. However, because the entire composite reflective surface is convex and because the second. convex curvatures are closely spaced apart on the reflective surface, depth perception remains problematic.

Thus, there is a need for improved rear view mirrors for large vehicles, which avoid problems associated with currently available rear view mirrors.

### SUMMARY OF THE DISCLOSURE

In one aspect, a mirror is disclosed. The mirror may include a continuous and predominantly convex reflective surface having an inner edge that extends between a top edge and a bottom edge. The continuous reflective surface may also have an outer edge that extends between the top and bottom edges. The continuous reflective surface may have a. curvature y defined by a horizontal quadratic equation, y=az²+bz+c, and a vertical quadratic equation, y=dx²+fx+g; wherein z may represent coordinates along a horizontal axis passing through the continuous effective surface; x represents coordinates along a vertical axis passing through the continuous reflective surface; a may be a horizontal. parabolic coefficient; b may be a horizontal linear coefficient; c may be a horizontal constant and may be zero; d may be a vertical parabolic coefficient; f may be a vertical linear coefficient; and g may be a vertical constant.

In another aspect, a rear view mirror for a vehicle is disclosed. The rear view mirror may include a continuous and predominantly convex reflective surface having an inner edge extending between a top edge and a bottom edge. The continuous reflective surface may also have an outer edge that extends between the top and bottom edges. The continuous reflective surface may further include a planar portion disposed between a top portion having a first curvature, an inner portion having a second curvature, a bottom portion having a third curvature and an outer portion having a fourth curvature. The continuous reflective surface may further be defined by a horizontal quadratic equation along horizontal axes extending between the inner and outer edges, and the continuous reflective surface may also be further defined by a vertical quadratic equation long vertical axes extending between the top and bottom edges.

In yet another aspect, a vehicle is disclosed that may include an operator cab having a front end and two sides. Each side may be coupled to a rear view mirror. Each rear view mirror may include a continuous and predominantly convex reflective surface having an inner edge that extends between a top edge and a bottom edge. The continuous reflective surface may also have an outer edge that extends between the top and bottom edges. The inner edge may be disposed between one side of the cab and its respective outer edge. The rear view mirror may include a continuous reflective surface having a curvature y defined by a horizontal quadratic equation, y=az²+bz+c, and a vertical quadratic equation, y=dx²+fx+g, wherein: z may represent coordinates along a horizontal axis passing through the continuous reflective surface; x may represent coordinates along a vertical axis passing through the continuous reflective surface; a may be a horizontal parabolic coefficient and may be about 0.0004; b may be a horizontal linear coefficient and may be about 0.03; c may be a horizontal constant and may be about 0; d may be a vertical parabolic coefficient and may be about 0.00025; f may be a vertical linear coefficient and may be about 0.05; and g may be a vertical constant and may be about 2.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a perspective view of a disclosed rear view mirror mounted to the operator side of a vehicle and further illustrating a rear view reflection provided by the disclosed continuous reflecting surface that has a horizontal curvature and a vertical curvature, both of which may be defined by quadratic or parabolic equations;

FIG. 2 is a rear perspective view of the reflecting surface of the mirror disclosed in FIG. 1;

FIG. 3 illustrates, graphically, a curvature of the reflecting surface along a horizontal axis (z) of the mirror illustrated in FIGS. 1 and 2; and

FIG. 4 illustrates, graphically, a curvature of the reflecting surface along a vertical axis (x) of the minor illustrated in FIGS. 1 and 2.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION OF THE PRESENTLY PREFERRED EMBODIMENTS

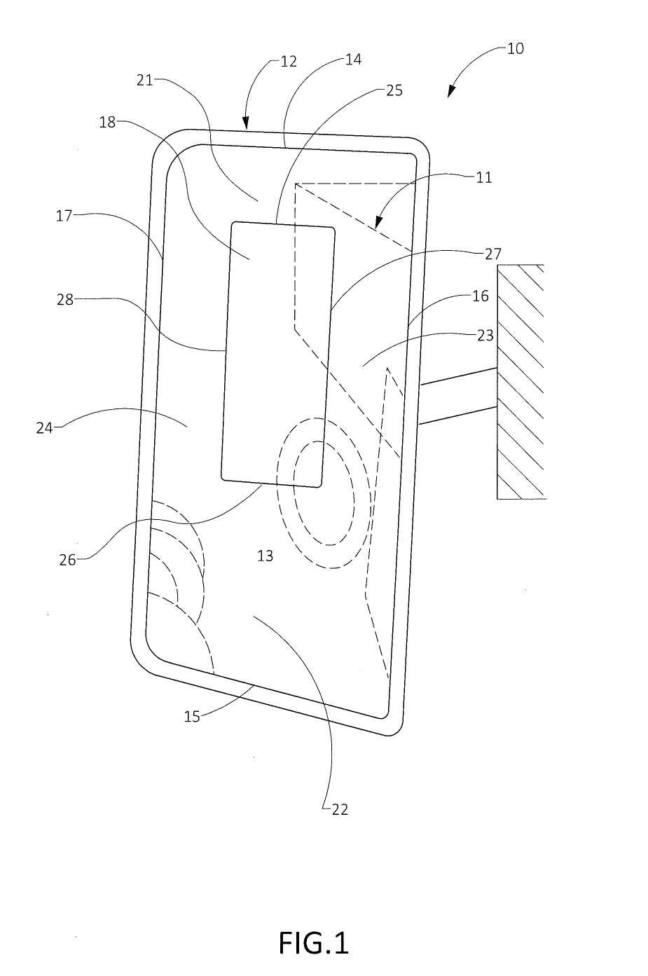

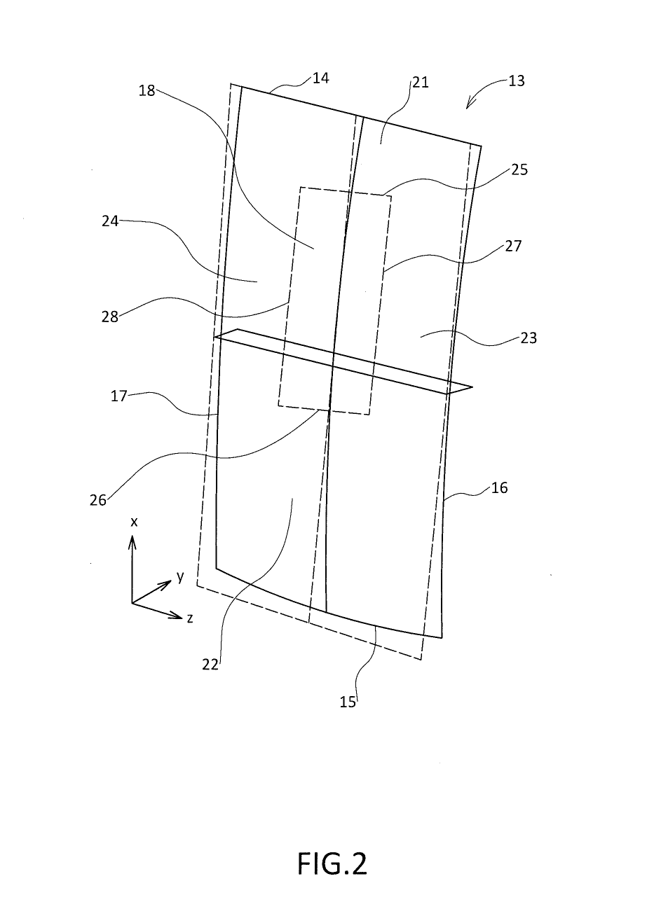

FIG. 1 illustrates a rear view provided by a disclosed rear view mirror 10 mounted to a truck 11 (shown schematically in FIG. 1). The disclosed rear view mirror 10 is particularly useful for larger trucks and vehicles, such as dump trucks. However, other applications will be apparent to those skilled in the art. The rear view minor 10 may be mounted to an operator's side of a truck 11 (see the reflection in the rear mirror 10) using a bracket (not shown). The rear view mirror 10 may include an outer frame 12 that surrounds a continuous reflective surface 13 that is bound by a top edge 14, a bottom edge 15, an inner edge 16 and an outer edge 17. The inner edge 16 is disposed between the truck 11 and the outer edge 17. The continuous reflective surface 13 has a curvature y that may be defined by a horizontal quadratic equation, y=az²+bz+c, and a vertical quadratic equation, y=dx²+fx+g. Specifically, in addition to the relatively planar portion 18, the continuous reflective surface 13 may also include a slightly convex top portion 21, a convex bottom portion 22, a slightly convex inner portion 23 and a convex outer portion 24. The relatively planar portion 18 may be bound by a top boundary 25, a bottom boundary 26, an inner boundary 27 and an outer boundary 28, also shown in FIG. 2 Because the relatively planar portion 18, the slightly convex top portion 21, the convex bottom portion 22, the slightly convex inner portion 23 and the convex outer portion 24 are all defined by the horizontal and vertical quadratic equations, the transition bet en the convex portions of the continuous reflective surface 13 and the relatively planar portion 18 is smooth, thereby minimizing distortion.

The relatively planar portion 18 may be moved about the continuous reflective surface 13 by manipulating one or more coefficients or constants of the horizontal and vertical quadratic equations as described below. As will be appreciated by those skilled in the art, it may he desirable to move the relatively planar portion 18 upward, downward, to the right or to the left, depending upon the particular application. For example, a non-distorted view may be desired closer to the top edge 14 of the rear view mirror 10 for some applications or closer to the bottom edge 15 of the rear view mirror 10 for other applications. Similarly, it may be desirable to move the relatively planar portion 18 closer to the inner edge 16 of the rear view mirror 10 for some applications and it may be better to move the relatively planar portion 18 towards the outer edge 17 for other applications.

Turning to FIG. 2, the continuous reflective surface 13 is illustrated without an outer frame 12. Again, the continuous reflective surface 13 is defined by a top edge 14, a bottom edge 15, an inner edge 16 and an outer edge 17. In the orientation shown in FIG. 2, the degree of curvature y extends into and out of the page and may be defined by two quadratic equations, including a horizontal quadratic equation and a vertical quadratic equation. The horizontal and vertical quadratic equations may be expressed as follows:

y=az²+bz+c(horizontal); and

y=dx²+fx+g(vertical);

wherein a may be a horizontal parabolic coefficient and may range from about −0.01 to about 0.01; b may be a horizontal linear coefficient and may range from about −20 to about 20; c may be a horizontal constant and may range from about −30 to about 30; d may be a vertical parabolic coefficient and may range from about −0.01 to about 0.01; f may be a vertical linear coefficient and may range from about −20 to about 20; and g may range from about −30 to about 30. The coefficients and constants a, b, c, d, f, and g may all vary, depending upon the particular application and depending upon where the end user desires tile: relatively planar portion 18 of the continuous reflective surface 13 to be disposed. Further, the vertical coordinates, x, may range from about 300 to about −300 mm and the horizontal coordinates, z, may range from about 170 to about −170 mm.

In one of many embodiments, a may be about 0.0004, b may be about 0.03, c may be about 0, d may be about 0.00025, f may be about 0.05 and g may be about 2, thereby providing the following quadratic equations for defining the curvature y of the continuous reflective surface 13 in one embodiment:

y=0.0004z²+0.03z(horizontal)

y=0.00025x²+0.05x+2(vertical)

Using the above equations or those similar thereto, a computer-generated model for the continuous reflective surface 13 may be produced and used to form a mold. The mold may be fabricated from diatomite or another suitable material, as will be apparent to those skilled in the art.

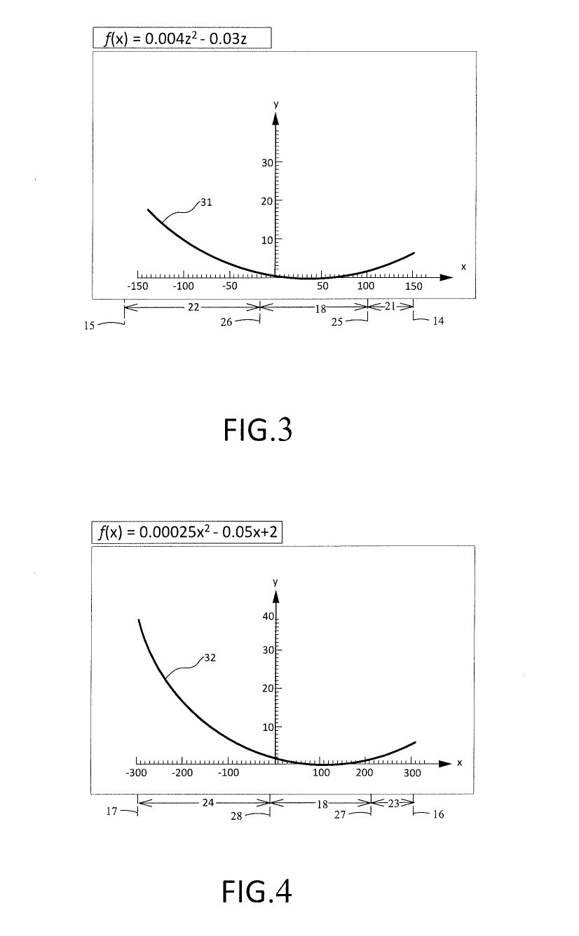

The horizontal and vertical equations are plotted separately in FIGS. 3 and 4 respectively. FIG. 3 graphically illustrates the curvature y of the continuous reflective surface 13 in the horizontal direction, represented by the horizontal parabola 31, that is defined by the horizontal quadratic equation y=0.0004z²-0.03z, where z represents coordinates along the horizontal axis and y represents the degree of curvature. The resulting horizontal parabola 31 defines: the slightly convex inner portion 23 disposed between the inner boundary 27 and the inner edge 16 (see FIG. 2); the relatively planar portion 18 disposed between the slightly convex inner portion 23 and the convex outer portion 24 (and between the inner and outer boundaries 27, 28); and the convex outer portion 24 disposed between the outer boundary 28 and the outer edge 17. The convex outer portion 24 has a higher degree of curvature, or is more convex, for an increased field of view, than the slightly convex inner portion 23. Thus, as shown in FIG. 3, the use of the quadratic equation, y=0.0004z²-0.03z, results in a slightly convex inner portion 23 disposed between the inner boundary 27 of the relatively planar portion 18 and the inner edge 16, followed by the relatively planar portion 18 (disposed between the inner and outer boundaries 27, 28), followed by the convex outer portion 24 disposed between the outer boundary 28 and the outer edge 17. In the illustrated embodiment, the width of the mirror 10 or continuous reflective surface 13 along the horizontal axis is about 340 mm wide (FIG. 3), while the height or length along the vertical axis is about 600 mm (FIG. 4).

Turning to FIG. 4, the vertical parabola 32 illustrates, graphically, the curvature y in the vertical direction as defined by the quadratic equation, y=0.00025x²-0.05x+2, where y is the degree of curvature and x represents coordinates along the vertical axis. As shown in FIGS. 2 and 4, the vertical parabola 32 defines the slightly convex top portion 21, which is disposed between the top boundary 25 and the top edge 14. The vertical parabola 32 also defines the relatively planar portion 18, which is disposed between the top and bottom boundaries 25, 26. Finally, the vertical parabola 32 defines the convex bottom portion 22, which is disposed between the bottom boundary 26 and the bottom edge 15. The convex bottom portion 22 is more convex, for a larger field of view, than the slightly convex top portion 21.

Returning to FIG. 3, the horizontal parabola 31 graphically illustrates the quadratic equation, y=0.0004z²-0.03z, where the horizontal parabolic coefficient (a) is about 0.0004, the horizontal linear coefficient (b) is about −0.03 and the linear constant (c) is about 0. Increasing the horizontal parabolic coefficient (a) from 0.0004 to 0.0006 may shift the relatively planar portion 18 in an outward direction or towards the outer edge 17 while decreasing the horizontal parabolic coefficient (a) from 0.0004 to 0.0002 may shift the relatively planar portion 18 towards the inner edge 16. Further, decreasing the horizontal linear coefficient (b) from 0.03 to 0.015 may shift the relatively planar portion 18 outwardly, while increasing the horizontal linear coefficient (b) from 0.03 to 0.045 may shift the relatively planar portion 18 inwardly. Further, adding a positive linear constant (c) at the end of the horizontal parabolic equation may shift the relatively planar portion 18 outwardly, while adding a negative linear constant (c) nay shift the relatively planar portion 18 inwardly.

Returning to FIG. 4, the vertical parabola 32 graphically illustrates the parabolic equation, y=0.00025 x²-0.05 x+2. To shift the relatively planar portion 18 downwards on the continuous reflective surface 13, the vertical parabolic coefficient (d) may be increased above 0.00025. In contrast, to shift the relatively planar portion 18 upwards on the continuous reflective surface 13, the vertical parabolic coefficient (d) may be decreased below 0.00025. Similarly, decreasing the vertical linear coefficient (f) below 0.05 may shift the relatively planar portion 18 downwards while increasing the vertical linear coefficient (f) above 0.05 may shift the relatively planar portion 18 upwards. Further, increasing the vertical constant (g) above 2 may shift the relatively planar portion 18 downwards while decreasing the vertical constant (g) below 2 may shift the relatively flat portion upwards.

One skilled in the art will be able to easily manipulate the horizontal parabolic coefficient (a), the horizontal linear coefficient (b), the horizontal constant (c), the vertical parabolic coefficient (d) the vertical linear coefficient (f) and the vertical constant (g) using various iterations to move and adjust the size of the relatively planar portion

### INDUSTRIAL APPLICABILITY

A rear view mirror 10 is disclosed which includes a continuous reflective surface 13 having portions or areas of different convexities. The continuous reflective surface 13 may be defined by two different quadratic equations, including a horizontal quadratic equation and a vertical quadratic equation. By defining the curvature y of the continuous reflective surface 13 to satisfy both a horizontal quadratic equation as well as a vertical quadratic equation, it has been found that a relatively planar portion 18 may be provided that provides the operator with improved depth perception in addition to the benefits provided by convex portions that surround the relatively planar portion 18. The horizontal quadratic equation defines the curvature of the continuous reflective surface 13 in the horizontal direction and may be expressed as y=az²-bz+c, wherein a is a horizontal parabolic coefficient and may range from about −0.01 to about 0.01, b is a horizontal linear coefficient and may range from about −20 to about 20, and c is a horizontal constant and may range from about −30 to about 30. The continuous reflective surface 13 may also be defined in a vertical direction by the vertical quadratic equation, y=dx²+fx+g, wherein d is a vertical parabolic coefficient and may range from about −0.01 to about 0.01, f is a vertical linear coefficient and may range from about −20 to about 20 and g is a constant and may range from about −30 to about 30.

The resulting rear view mirror 10 has a relatively planar portion 18 that may be surrounded by more convex portions, including: a slightly convex top portion 21 disposed above the relatively planar portion 18; a convex bottom portion 22 disposed below the relatively planar portion 18; a slightly convex inner portion 23 disposed between the relatively planar portion 18 and the inner edge 16; and a convex outer portion 24 disposed between the relatively planar portion 18 and the outer edge 17 of the continuous reflective surface 13. As indicated above, the relatively planar portion 18 may be moved upwards, downwards, inwards and outwards on the continuous reflective surface 13 by manipulating the coefficients and constants of the horizontal and vertical quadratic (parabolic) equations.

While only certain embodiments have been set forth, alternatives and modifications be apparent from the above description to those skilled in the art. These and other alternatives are considered equivalents and within the spirit and scope of this disclosure and the appended claims.

What is claimed:

1. A mirror comprising:
a continuous reflective surface having an inner edge extending between a top edge and a bottom edge, the continuous reflective surface also having an outer edge extending between the top and bottom edges,
the continuous reflective surface having a curvature y defined by a horizontal quadratic equation, y=az²+bz+c, and a vertical quadratic equation, y=dx²+fx+g,
wherein z represents coordinates along a horizontal axis passing through the continuous reflective surface,
wherein x represents coordinates along a vertical axis passing through the continuous reflective surface,
wherein a is a horizontal parabolic coefficient, b is a horizontal linear coefficient, c is a horizontal constant, d is a vertical parabolic coefficient, f is a vertical linear coefficient and negative and g is a vertical constant.

2. The mirror of claim 1 wherein a ranges from about −0.01 to about 0.01.

3. The mirror of claim 1 wherein a is about 0.0004.

4. The mirror of claim 1 wherein b ranges from about −20 to about 20.

5. The mirror of claim 1 wherein b is about −0.03.

6. The mirror of claim 1 wherein c ranges from about −30 to about 30.

7. The mirror of claim 1 wherein c is about 0.

8. The mirror of claim 1 wherein d ranges from about −0.01 to about 0.01.

9. The mirror of claim 1 wherein d is about 0.00025.

10. The mirror of claim 1 wherein f ranges from about −20 to about 20.

11. The mirror of claim 1 wherein f is about −0.05.

12. The mirror of claim 1 wherein g ranges from about −1 30 to about 30.

13. The mirror of claim 1 wherein g is about 2.

14. The mirror of claim 1 wherein a ranges from about −0.01 to about 0.01, b ranges from about −20 to about 20, c ranges from about −1 to about 1, d ranges from about −0.01 to about 0.01, f ranges from about −20 to about 20 and g ranges from about −30 to about 30.

15. The mirror of claim 1 wherein a is about 0.0004, b is about −0.03, c is about 0, d is about 0.00025, f is about −0.05 and g is about 2.

16. A rear view mirror for a vehicle, comprising:
a continuous reflective surface having an inner edge extending between a top edge and a bottom edge, the continuous reflective surface also having an outer edge extending between the top and bottom edges,
the continuous reflective surface further including a planar portion disposed between a top portion having a first curvature, an inner portion having a second curvature, a bottom portion having a third curvature and an outer portion having a fourth curvature,
wherein the continuous reflective surface further being defined by a horizontal quadratic equation along horizontal axes extending between the inner and outer edges, and
wherein the continuous reflective surface further being defined by a vertical quadratic equation long vertical axes extending between the top and bottom edges.

17. The rear view mirror of claim 16 wherein the horizontal quadratic equation is y=az²+bz+c, and the vertical quadratic equation is y=dx²+fx+g,
wherein z represents coordinates along a horizontal axis passing through the continuous reflective surface,
wherein x represents coordinates along a vertical axis passing through the continuous reflective surface, and
wherein a ranges from about −0.01 to about 0.01, b ranges from about −20 to about 20, c ranges from about −30 to about 30, d ranges from about −0.01 to about 0.01, f ranges from about −20 to about 20 and g ranges from about −30 to about 30.

18. The rear view mirror of claim 17 wherein a is about 0.0004, b is about −0.03 and c is about 0.

19. The rear view mirror of claim 17 wherein d is about 0.00025, f is about −0.05 and g is about 2.

20. A vehicle comprising:
an operator cab having a front end and two sides, each side being coupled to a rear view mirror, each rear view mirror including a continuous reflective surface having an inner edge extending between a top edge and a bottom edge, the continuous reflective surface also having an outer edge extending between the top and bottom edges, the inner edge being disposed between one side of the cab and its respective outer edge,
the continuous reflective surface having a curvature y defined by a horizontal quadratic equation, y=az²+bz+c, and a vertical quadratic equation, y=dx²+fx+g,
wherein z represents coordinates along a horizontal axis passing through the continuous reflective surface,
wherein x represents coordinates along a vertical axis passing through the continuous reflective surface, and
wherein a is about 0.0004, b is about −0.03, c is about 0, d is about 0.00025, f is about −0.05 and g is about 2.
